(19) United States
(12) Patent Application Publication
(10) Pub. No.: US 2011/0046040 A1
(43) Pub. Date: Feb. 24, 2011

(54) Microorganism-inactivating agent

(75) Inventors: Masamichi MUTOU, Yokohama-shi (JP); Fumiko HIROTA, Yokohama-shi (JP)

Correspondence Address: HOGAN LOVELLS US LLP;IP GROUP, COLUMBIA SQUARE, 555 THIRTEENTH STREET, N.W., WASHINGTON, DC, 20004, US

(73) Assignee: CHISSO CORPORATION, Osaka-shi, Osaka (JP)

(21) Appl. No.: 12/859,128

(22) Filed: Aug. 18, 2010

(30) Foreign Application Priority Data
Aug. 20, 2009 (JP) 2009-190719

(51) Int. Cl. A01N 37/44; A01P 1/00

(52) U.S. Cl. 514/2.7; 514/2.3

(57) ABSTRACT

With a microorganism-inactivating agent comprising a composition containing γ-polyglutamic acid and/or cross-linked product of γ-polyglutamic acid; a calcium ion donor; a sodium ion donor; and an aluminum ion donor, microorganisms in water are inactivated. By further including one or more selected from microbiostatic agents and microbicides into the microorganism-inactivating agent, various microorganisms in water are inactivated to a level at which the water is suitable for drinking.

### BACKGROUND OF THE INVENTION

1. Field of the Invention

The present invention relates to a microorganism-inactivating agent, a method for inactivating a microorganism, and a method for producing drinking water.

2. Brief Description of the Related Art

In waters of rivers, lakes and the like which are used as raw water for drinking water and domestic water, there exist pathogenic bacteria such as Staphylococcus.

Especially, Staphylococcus are known as pathogenic bacteria that cause various inflammation in human and animals, such as purulent skin disease, conjunctivitis, sinusitis, otitis media, cystitis, pneumonia, osteomyelitis, arthritis and visceral abscess. Especially, Staphylococcus aureus (S. aureus) is a major pathogenic bacterium of suppuration in human and animals, and it is also a pathogenic bacterium of food poisoning for which enterotoxin produced thereby is responsible.

According to the water quality standard for drinking water stipulated by the Water Supply Act, Staphylococcus in water must be inactivated to make the water suitable for drinking, and therefore sterilization is usually carried out with chlorate. Also in domestic waters such as pool water and bath water, the existence of Staphylococcus and the like is not preferred, so that sterilization is usually carried out as in drinking water.

However, in developing countries and the like, plumbing is not installed enough, and there are as many as 1.7 billion people who cannot have safe drinking water, so that, nowadays, 5000 people/day including many children die because of food poisoning from drinking water. Therefore, a simple processing method for supplying safe drinking water is demanded. Further, also in cases where plumbing is not available because of a disaster such as an earthquake, an alternative means which does not require power and large-scale facilities is necessary.

In general, when inactivation treatment of microorganisms is carried out, an antibiotic, microbicide, antimicrobial agent or the like is used, but such an agent having a strong effect has a problem in view of safety when it is applied to drinking water.

Under these circumstances, a method for simply inactivating microorganisms such as Staphylococcus to obtain drinking water or domestic water is demanded.

γ-polyglutamic acid and radiation-cross-linked product thereof are anionic polymers, and in recent years, compositions comprising them as major components have been developed. Said compositions are so far known to have functions to cause aggregation and precipitation of pollutants, metal ions and dioxins in wastewater and tap water and functions to cause aggregation of a food and a fermentation product of interest in a food-containing water and a fermentation liquid to obtain the resultant (Patent Document 1).

However, it was not known that a composition comprising as a major component γ-polyglutamic acid or cross-linked product thereof is capable of inactivating microorganisms such as Staphylococcus.

### PRIOR ART DOCUMENTS

[Patent Document 1] JP 2002-210307 A

[Patent Document 2] JP 2004-174326 A

[Patent Document 3] JP 2004-202441 A

### SUMMARY OF THE INVENTION

It is an object of the present invention to provide a method for simply inactivating microorganisms in water. It is also an object of the present invention to provide a method for simply producing drinking water.

The present inventors intensively studied to solve the above problems. As a result, we found that a composition comprising as a major component(s) γ-polyglutamic acid and/or cross-linked product thereof is capable of inactivating microorganisms. Based on the finding, the present inventors completed the present invention.

That is, the present invention is as follows.

(1) A microorganism-inactivating agent comprising a composition containing γ-polyglutamic acid and/or cross-linked product of γ-polyglutamic acid; a calcium ion donor; a sodium ion donor; and an aluminum ion donor.
(2) The microorganism-inactivating agent according to (1), further comprising one or more selected from microbiostatic agents and microbicides.
(3) The microorganism-inactivating agent according to (2), wherein said microbiostatic agents and microbicides are cationic compound.
(4) The microorganism-inactivating agent according to (3), wherein said cationic compound is polypeptide mainly consisting of basic amino acids.
(5) The microorganism-inactivating agent according to (4), wherein said polypeptide is ε-poly-L-lysine.
(6) The microorganism-inactivating agent according to (5), wherein the mass ratio between the contents of said composition and said ε-poly-L-lysine is 1:10 to 500:1.
(7) A method for inactivating a microorganism in water containing said microorganism, comprising a step of bringing a composition containing γ-polyglutamic acid and/or cross-linked product of γ-polyglutamic acid; a calcium ion donor; a sodium ion donor; and an aluminum ion donor into contact with said water containing said microorganism.
(8) The method according to (7), wherein said step of bringing the composition into contact with water comprises adding said composition to said water containing said microorganism and stirring said water after the addition.
(9) The method according to (7) or (8), wherein said microorganism belongs to the genus Staphylococcus.
(10) The method according to any one of (7) to (9), further comprising a step of bringing one or more selected from microbiostatic agents and microbicides into contact with said water containing said microorganism.
(11) The method according to (10), wherein a composition containing γ-polyglutamic acid and/or cross-linked product of γ-polyglutamic acid; a calcium ion donor; a sodium ion donor; and an aluminum ion donor; and one or more selected from microbiostatic agents and microbicides are added to water at the same time and brought into contact with the water.
(12) The method according to (10) or (11) wherein said microbiostatic agents and microbicides are cationic compound.
(13) The method according to (12), wherein said cationic compound is polypeptide mainly consisting of basic amino acids.
(14) The method according to (13), wherein said polypeptide is ε-poly-L-lysine.
(15) The method according to (14), wherein said composition is added to a concentration of 1 to 50000 ppm and said ε-poly-L-lysine is added to a concentration of 0.1 to 100 ppm.
(16) The method according to (14) or (15), wherein said composition and said ε-poly-L-lysine is added such that the mass concentration ratio between them is 1:10 to 500:1.
(17) A method for producing drinking water comprising inactivating a microorganism in water by the method according to any one of (10) to (16).

By the present invention, a method for simply inactivating microorganisms in water is provided, and drinking water and domestic water can be simply obtained.

### DESCRIPTION OF THE PREFERRED EMBODIMENTS

The microorganism-inactivating agent of the present invention comprises a composition containing as a major component(s) γ-polyglutamic acid and/or cross-linked product thereof. More particularly, it comprises a composition containing γ-polyglutamic acid and/or cross-linked product of γ-polyglutamic acid; a calcium ion donor; a sodium ion donor; and an aluminum ion donor. In the γ-polyglutamic acid and the cross-linked product of γ-polyglutamic acid, the γ-polyglutamic acid may be salts in part or entirely.

The γ-polyglutamic acid in the composition related to the microorganism-inactivating agent of the present invention can be produced by a known method such as a fermentation method by a microorganism or a chemical synthesis method, as disclosed in JP 2002-210307 A.

The weight average molecular weight of the γ-polyglutamic acid is preferably distributed between several hundred thousand to several million as measured by gel permeation chromatography, and it is preferably ten million or less than ten million. In the γ-polyglutamic acid, amino acids other than glutamic acid may also be included. In such cases, the content of the amino acids other than glutamic acid is preferably 10% by mass or less than 10% by mass.

Cross-linked product of γ-polyglutamic acid and γ-polyglutamate can be produced, for example, by cross-linking γ-polyglutamate by radiation, as disclosed in JP 2002-210307A. The γ-polyglutamate to be cross-linked can be obtained by neutralization reaction of γ-polyglutamic acid with a basic compound, as disclosed in JP 2002-210307A. Examples of the basic compound include hydroxides of alkaline metals and alkaline earth metals, and particular examples thereof include sodium hydroxide, potassium hydroxide, magnesium hydroxide, calcium hydroxide, barium hydroxide and organic basic compounds such as amines.

The cross-linked product of γ-polyglutamic acid preferably has a degree of cross-linking at which 2 to 1000 linear chains of γ-polyglutamic acid chloride are cross linked. The weight average molecular weight of the cross-linked product of γ-polyglutamic acid is preferably ten million to one hundred million as measured by gel permeation chromatography.

In the composition related to the microorganism-inactivating agent of the present invention, the content of γ-polyglutamic acid and/or cross-linked product thereof is preferably 0.1 to 30% by mass, more preferably 0.5 to 20% by mass.

Examples of the calcium ion donor in the composition related to the microorganism-inactivating agent of the present invention include calcium sulfate, calcium carbonate and calcium phosphate, and one or more of these may be used. Preferably, calcium sulfate and calcium carbonate are used. In the composition related to the microorganism-inactivating agent of the present invention, the content of the calcium ion donor is preferably 40 to 90% by mass, more preferably 80 to 90% by mass.

Examples of the sodium ion donor in the composition related to the microorganism-inactivating agent of the present invention include sodium carbonate, sodium hydrogen carbonate, sodium chloride, sodium silicate and sodium phosphate, and one or more of these may be used. Preferably, sodium carbonate is used. In the composition related to the microorganism-inactivating agent of the present invention, the content of the sodium ion donor is preferably 0.1 to 20% by mass, more preferably 0.1 to 10% by mass.

Examples of the aluminum ion donor in the composition related to the microorganism-inactivating agent of the present invention include aluminum sulfate, aluminum chloride and polyaluminum chloride, and one or more of these may be used. Preferably, aluminum sulfate is used. In the composition related to the microorganism-inactivating agent of the present invention, the content of the aluminum ion donor is preferably 0.01 to 10% by mass, more preferably 0.1 to 5% by mass.

Further, the composition related to the microorganism-inactivating agent of the present invention may contain, in addition to the above metal ion donors, an iron ion donor and/or a magnesium ion donor. Examples of the iron ion donor include ferric sulfate and ferric chloride, and examples of the magnesium ion donor include magnesium oxide and magnesium chloride.

The preferred components and the contents thereof in the composition related to the microorganism-inactivating agent of the present invention are 1 to 10% by mass of the cross-linked product of γ-polyglutamic acid, 70 to 80% by mass of calcium sulfate, 10 to 20% by mass of calcium carbonate, 1 to 10% by mass of sodium carbonate and 0.1 to 3% by mass of aluminum sulfate. This can be obtained as a commercially available product, PGα21Ca (Nippon Poly-Glu Co., Ltd.).

The microorganism-inactivating agent of the present invention forms suspended particles in water, and microorganisms in the water are adsorbed to the suspended particles. Since the microorganisms adsorbed to the suspended particles precipitate by still standing, the supernatant of the water after the processing does not contain active microorganisms. In the present specification, inactivation of microorganisms includes not only microbiostasis and/or sterilization of microorganisms, but also making the supernatant of water after the processing free from active microorganisms (that is, to eliminate active microorganisms from the supernatant) as mentioned above. The microorganism-inactivating agent of the present invention has an excellent effect of elimination and inactivation of Staphylococcus and yeast. Such an action has not been known for a composition comprising as a major component(s) γ-polyglutamic acid and/or cross-linked product of γ-polyglutamic acid.

The microorganism-inactivating agent of the present invention may further comprise one or more selected from microbiostatic agents and microbicides. Such microbiostatic agents and microbicides preferably inactivate microorganisms other than Staphylococcus. By combining the composition comprising as a major component(s) γ-polyglutamic acid and/or cross-linked product of γ-polyglutamic acid with the one or more selected from microbiostatic agents and microbicides, various microorganisms can be inactivated.

Here, the microbiostatic agents and the microbicides employed are those acceptable in view of hominal physiology, such as food additives. Examples of the microbiostatic agents and the microbicides used in the present invention include cationic compound, grapefruit seed extracts and triclosan. Examples of the cationic compound include polycationic compound and quaternary ammonium salts, and examples of the polycationic compound include polypeptides mainly consisting of basic amino acids, whose preferred examples include ε-poly-L-lysine and protamine in which basic amino acids constitute 60 mol % or more than 60 mol % thereof.

ε-poly-L-lysine is known to have microbicidal actions and used as food additives (JP 63-109762 A).

The protamine is the general term of histone-like peptides derived from sperm nuclei of fish such as salmon and herring, which are polypeptides having arginine-rich structures. Protamine is also known to have antimicrobial properties and also used as food additives (T. Motohiro: Bio Industry, 6(2), 5 (1989)).

The degrees of polymerization of these polypeptides are not restricted, and preferably 1000 to 5000.

As shown in the below-mentioned Example (Test Example 2), these substances can inactivate microorganisms such as Escherichia coli and Salmonella existing in water. Therefore, by employing these in the microorganism-inactivating agent of the present invention in combination with the composition containing γ-polyglutamic acid and/or cross-linked product of γ-polyglutamic acid, various microorganisms existing in water can be simply inactivated.

In particular, ε-poly-L-lysine is different from common chlorinated microbicides in that its inactivation action can be maintained for a long time, which is preferred. That is, they enable long-term preservation of water after the inactivation process without their further addition, and microorganisms emerged after the process can also be suppressed, so that they are suitable for processing of drinking water and domestic water.

As shown in the below-mentioned Example (Test Example 3), in spite of the fact that ε-poly-L-lysine and protamine are polycationic, their coexistence with γ-polyglutamic acid, cross-linked product of γ-polyglutamic acid and the like which are polyanionic does not cancel each other's functions. This is an unexpected phenomenon when the studies of the present invention started, which is a highly important discovery.

The microorganism-inactivating agent of the present invention containing one or more selected from the above-described microbiostatic agents and microbicides can inactivate microorganisms, at one time, which may generally exist in tap water, wastewater, rivers, lakes and the like. More particularly, microorganisms such as Gram-negative bacteria including Escherichia coli, Salmonella, Pseudomonas aeruginos and Klebsiella pneumoniae; Gram-positive bacteria including Staphylococcus, Bacillus subtilis, Bacillus cereus and Listeria monocytogenes; yeast; and the like can be inactivated.

The microorganism-inactivating agent of the present invention may be in the form of a kit which enables simultaneous use of a composition containing as a major component(s) γ-polyglutamic acid and/or cross-linked product of γ-polyglutamic acid and one or more selected from microbiostatic agents and microbicides, or in the form wherein these are contained in a compounding agent. The form of a compounding agent is preferred since the composition and the one or more selected from microbiostatic agents and microbicides can be simply used at one time.

The method for inactivation of microorganisms of the present invention comprises a step of bringing a composition containing γ-polyglutamic acid and/or cross-linked product of γ-polyglutamic acid; a calcium ion donor; a sodium ion donor; and an aluminum ion donor into contact with water containing a microorganism. The step of bringing the composition into contact may be carried out by a step of adding the composition to the water containing a microorganism and a step of stirring the water after the addition; by storing the water containing a microorganism in a water tank (container) in which the composition is immobilized; or by allowing the water containing a microorganism to pass through a passage (water filling pipe, drain pipe, circulation pathway of water, or the like) in which the composition is immobilized. In view of simplicity of the procedure, it is preferably carried out by a step of adding the composition to the water containing a microorganism and a step of stirring the water after the addition. After the step of bringing the composition into contact, a step of still standing of the water may further be carried out. As shown in the below-mentioned Example (Test Example 1), microorganisms in water, especially Staphylococcus and yeast can be inactivated by the method of the present invention.

Further, in addition to the composition containing γ-polyglutamic acid and/or cross-linked product of γ-polyglutamic acid; a calcium ion donor; a sodium ion donor; and an aluminum ion donor, the one or more selected from microbiostatic agents and microbicides may be added at the same time or sequentially. Their simultaneous addition is preferred since the process of inactivation of microorganisms can be simply carried out.

In the method wherein the composition containing γ-polyglutamic acid and/or cross-linked product of γ-polyglutamic acid; a calcium ion donor; a sodium ion donor; and an aluminum ion donor is used at the same time together with a poly-L-lysine, long-term inactivation of microorganisms in water can be attained by the following mode. Possible examples of the mode include one wherein ε-poly-L-lysine immobilized to a fiber or the like is allowed to exist in a water tank (container). Examples of the water tank include feed water tanks, swimming pools, fountains and ponds. Further, there is also a possible mode wherein ε-poly-L-lysine is allowed to exist by immobilization and so on in a circulation pathway of water such as a water filling pipe, drain pipe or outdoor unit of an air conditioner, and water containing microorganisms is allowed to pass through the passage, to inactivate microorganisms which were newly brought into contact with ε-poly-L-lysine.

By employing the method of the present invention, drinking water and domestic water in which microorganisms are inactivated can be simply obtained. In such cases, the supernatant of the water processed using the method of the present invention can be provided for drinking, swimming pools and baths, without removing the inactivating agent. Of course, the processing may be followed by filtration to provide the resulting filtrate for drinking and the like.

In cases where drinking water is produced by the method of the present invention, examples of the raw water include not only natural water in rivers, lakes and the like, but also tap water and wastewater.

In the method of the present invention, the composition containing as a major component(s) γ-polyglutamic acid and/or cross-linked product of γ-polyglutamic acid in the microorganism-inactivating agent may be contained in water at an arbitrary concentration within the physically acceptable range. In particular, in cases where Staphylococcus is inactivated, γ-polyglutamic acid and/or cross-linked product of γ-polyglutamic acid are/is added such that a concentration of 1 to 50000 ppm, preferably 10 to 10000 ppm, especially preferably 50 to 5000 ppm is attained with respect to the total amount of the water and the composition. Within this range, for example, in water containing 10⁶ cells/mL or more than 10⁶ cells/mL of Staphylococcus, the Staphylococcus can be inactivated to 10³ cells/mL or less than 10³ cells/mL, at which the water is acceptable for drinking. This effect can be obtained in 30 minutes, preferably 2 hours after addition of the composition.

In the method of the present invention, the one or more selected from microbiostatic agents and microbicides can be contained in water at an arbitrary concentration within the physically acceptable range. In particular, in cases where the microorganism-inactivating agent is ε-poly-L-lysine, it is added such that a concentration of 0.1 to 100 ppm, preferably 0.5 to 50 ppm is attained with respect to the total amount of the water and the composition. Within this range, for example, in water containing 10⁷ cells/mL or more than 10⁷ cells/mL of Escherichia coli or Salmonella, these bacteria can be inactivated to 10² cells/mL or less than 10² cells/mL, at which the water is acceptable for drinking. This effect can be obtained in 1 hour, preferably 2 hours after addition of the composition.

In the method of the present invention, in cases where the composition containing as a major component(s) γ-polyglutamic acid and/or cross-linked product of γ-polyglutamic acid and ε-poly-L-lysine as a microbicide are added, the composition is added such that a concentration of 1 to 50000 ppm, preferably 10 to 10000 ppm, especially preferably 50 to 5000 ppm is attained with respect to the total amount of the water and the composition, and the ε-poly-L-lysine is added such that a concentration of 0.1 to 100 ppm, preferably 0.5 to 50 ppm is attained with respect to the total amount of the water, the composition and the ε-poly-L-lysine. Further, the composition and the ε-poly-L-lysine are added such that the mass concentration ratio of 1:10 to 500:1, preferably 1:2 to 200:1, still preferably 2.5:1 to 200:1 is attained therebetween. Within this range, for example in water, each containing 10⁶ cells/mL of Staphylococcus, Escherichia coli or Salmonella, these bacteria can be inactivated to 10² cells/mL or less than 10² cells/mL, at which the water is acceptable for drinking. This effect can be obtained in 1 hour, preferably 2 hours after addition of the composition.

The method of the present invention can be applied to water having an arbitrary pH, and is used especially at a pH of 6 to 9, preferably 6.5 to 8.

Further, the method of the present invention can be applied to water at an arbitrary temperature, and the process can be carried out sufficiently without heating or cooling as long as the temperature is room temperature or normal temperature.

### EXAMPLES

The present invention will now be described in more detail by way of Examples, but the present invention is not restricted to these Examples.

In each test mentioned below, the effect of inactivation of microorganisms was measured according to the following process.

### <Preparation of Test Microorganisms>

Each test microbe was inoculated to nutrient broth and cultured with shaking at the optimum temperature of the test microbe until the late logarithmic phase. From the microbe culture, the microbe was collected, and the collected microbe was washed with 1.5 mL of physiological saline 2 to 3 times (centrifugation at 13000 rpm for 1 minute) and suspended in 1.5 mL of physiological saline. From the suspension, a 1 mL aliquot was recovered, and this was added to 9 mL of sterile water, followed by sufficient stirring of the resulting suspension (this was used as 10⁻¹ dilution). From the 10⁻¹ dilution, 10⁻² to 10⁻⁸ dilutions were sequentially prepared. Each dilution was smeared on a film medium (Sanita-kun; for E. coli and coliform bacteria, for Staphylococcus aureus, for Salmonella, for aerobic bacteria or for fungi: Chisso Corporation) in an amount of 1 mL, followed by culturing at the optimum temperature of the test microbe for 24 to 72 hours and measurement of the number of cells on the film medium.

### <Measurement of Effect of Inactivation of Microorganisms>

To a sterilized beaker, 500 mL of sterilized water was placed, and 0.20 mL of microbe culture of 10⁶ to 10¹⁰ cells/mL was inoculated thereto, to attain an initial cell number of 10³ to 10⁷ cells/mL. Unless otherwise specified, the pH was 6 to 8. After stirring the suspension gently for 5 minutes, PGα21Ca (Nippon Poly-Glu Co., Ltd.) and/or a microbiostatic agent or microbicide was/were added thereto such that a predetermined final concentration(s) was/were attained. After gentle stirring at room temperature for 10 to 15 minutes, the suspension was left to stand for a predetermined length of time. The supernatant was collected and diluted appropriately in an antimicrobial agent-inactivating medium (BHI medium or the like), and 1 mL each of the resulting diluent was smeared on a film medium. Culturing was carried out at the optimum temperature of each test microbe for 24 to 72 hours and the number of cells (cells/mL) on the film medium was measured.

The PGα21Ca was a mixture having a composition of 1 to 10% by mass of cross-linked product of γ-polyglutamic acid, 70 to 80% by mass of calcium sulfate, 10 to 20% by mass of calcium carbonate, 1 to 10% by mass of sodium carbonate and less than 3% by mass of aluminum sulfate.

In terms of the microbiostatic agent or microbicide, the followings were used.

ε-poly-L-lysine: 50% ε-poly-L-lysine powder, 25% aqueous ε-poly-L-lysine solution (Chisso Corporation)

Protamine: salmon-derived protamine sulfate (corporate name: Wako Pure Chemicals)

Grapefruit seed extract: DF-100 (corporate name: Chemie Research & Manufacturing Co Inc)

For the test, Escherichia coli, Salmonella enterica, Salmonella choleraesuis, Pseudomonas aeruginosa, Klebsiella pneumoniae, Staphylococcus aureus, Bacillus subtilis, Bacillus cereus, Listeria monocytogenes and yeast (Candida albicans and Pichia anomala) were used.

### Test Example 1

### The Effect of the Composition Related to the Microorganism-Inactivating Agent of the Present Invention Upon its Single Application

(1) The inactivation effect of PGα21Ca, which is a composition related to the microorganism-inactivating agent of the present invention, upon its single application to water containing Escherichia coli, Salmonella, Staphylococcus, Pseudomonas aeruginosa, Bacillus cereus, Klebsiella pneumoniae or Listeria monocytogenes was studied. The results are shown in Table 1. It can be seen that these microorganisms were inactivated by the PGα21Ca, and that high effects were obtained against Staphylococcus and Pseudomonas aeruginosa.

TABLE 1

| | | Initial number | | |
|---|---|---|---|---|
| PGα21Ca | | of microbe | 30 minutes | 20 hours |
| (ppm) | Microbe tested | (cells/mL) | later | later |
| 0 | E. coli | 8.0 × 10⁶ | 3.6 × 10⁶ | 4.2 × 10⁶ |
| | S. enterica | 2.5 × 10⁶ | 9.0 × 10⁵ | 6.0 × 10⁵ |
| | S. aureus | 2.5 × 10⁶ | 1.2 × 10⁶ | 1.2 × 10⁶ |
| | P. aeruginosa | 2.8 × 10⁶ | 2.6 × 10⁶ | 1.1 × 10⁶ |
| | B. cereus | 6.0 × 10⁵ | 2.8 × 10⁵ | 2.0 × 10⁵ |
| | K. pneumoniae | 2.0 × 10⁷ | 4.2 × 10⁶ | 5.2 × 10⁶ |
| | L. monocytogenes | 4.3 × 10⁶ | 1.4 × 10⁶ | 1.5 × 10⁶ |
| 50 | E. coli | 8.0 × 10⁶ | 5.2 × 10⁵ | <10 |
| | S. enterica | 2.5 × 10⁶ | 1.4 × 10⁵ | 40 |
| | S. aureus | 2.5 × 10⁶ | 9.0 × 10³ | <10 |
| | P. aeruginosa | 2.8 × 10⁶ | 2.6 × 10³ | 460 |
| | B. cereus | 6.0 × 10⁵ | 7.0 × 10⁴ | 2.3 × 10³ |
| | K. pneumoniae | 2.0 × 10⁷ | 3.4 × 10⁶ | 2.5 × 10³ |
| | L. monocytogenes | 4.3 × 10⁶ | 2.8 × 10⁵ | 5.4 × 10³ |
| 100 | E. coli | 8.0 × 10⁶ | 5.0 × 10⁵ | 20 |
| | S. enterica | 2.5 × 10⁶ | 1.4 × 10⁵ | 1.0 × 10³ |
| | S. aureus | 2.5 × 10⁶ | 1.8 × 10³ | <10 |
| | P. aeruginosa | 2.8 × 10⁶ | 2.0 × 10³ | 350 |
| | B. cereus | 6.0 × 10⁵ | 1.0 × 10⁴ | 260 |
| | K. pneumoniae | 2.0 × 10⁷ | 2.3 × 10⁶ | 2.0 × 10³ |
| | L. monocytogenes | 4.3 × 10⁶ | 1.0 × 10⁴ | 3.5 × 10³ |
| 500 | E. coli | 8.0 × 10⁶ | 1.6 × 10⁵ | <10 |
| | S. enterica | 2.5 × 10⁶ | 2.6. × 10⁵ | 3.0 × 10³ |
| | S. aureus | 2.5 × 10⁶ | 4.0 × 10³ | <10 |
| | P. aeruginosa | 2.8 × 10⁶ | 1.2 × 10³ | <10 |
| | B. cereus | 6.0 × 10⁵ | 1.0 × 10³ | <10 |
| | K. pneumoniae | 2.0 × 10⁷ | 8.1 × 10⁵ | 500 |
| | L. monocytogenes | 4.3 × 10⁶ | 2.0 × 10⁴ | 830 |
| 1000 | E. coli | 8.0 × 10⁶ | 4.0 × 10⁴ | <10 |
| | S. enterica | 2.5 × 10⁶ | 4.0 × 10⁴ | 5.2 × 10³ |
| | S. aureus | 2.5 × 10⁶ | 3.0 × 10³ | <10 |
| | P. aeruginosa | 2.8 × 10⁶ | 1.0 × 10³ | <10 |
| | B. cereus | 6.0 × 10⁵ | 500 | <10 |
| | K. pneumoniae | 2.0 × 10⁷ | 2.0 × 10⁴ | 200 |
| | L. monocytogenes | 4.3 × 10⁶ | 130 | 10 |
| 5000 | E. coli | 8.0 × 10⁶ | 2.0 × 10³ | <10 |
| | S. enterica | 2.5 × 10⁶ | 4.0 × 10⁴ | 1.6 × 10⁴ |
| | S. aureus | 2.5 × 10⁶ | 100 | <10 |
| | P. aeruginosa | 2.8 × 10⁶ | 800 | <10 |
| | B. cereus | 6.0 × 10⁵ | 100 | <10 |
| | K. pneumoniae | 2.0 × 10⁷ | 500 | 70 |
| | L. monocytogenes | 4.3 × 10⁶ | 70 | <10 |

(2) The inactivation effect of PGα21Ca, which is a composition related to the microorganism-inactivating agent of the present invention, upon its single application to water containing yeast was studied. The results are shown in Table 2. By these, it can be seen that the microorganism-inactivating agent of the present invention also has an inactivation effect against yeast, although exertion of the effect is slow.

TABLE 2

| | | Initial | | | | |
|---|---|---|---|---|---|---|
| | | number of | | | | |
| PGα21Ca | Microbe | microbe | 0.5 hour | | 2 hours | 4 hours |
| (ppm) | tested | (cells/mL) | later | 1 hour later | later | later |
| 0 | C. albicans | 1.5 × 10⁵ | 8.4 × 10⁴ | 7.2 × 10⁴ | 4.6 × 10⁴ | 5.2 × 10⁴ |
| | P. anomala | 6.1 × 10⁴ | 5.0 × 10⁴ | 3.6 × 10⁴ | 3.6 × 10⁴ | 3.8 × 10⁴ |
| 50 | C. albicans | 1.5 × 10⁵ | 5.2 × 10⁴ | 2.8 × 10⁴ | 1.2 × 10⁴ | 1.1 × 10³ |
| | P. anomala | 6.1 × 10⁴ | 6.4 × 10³ | 1.7 × 10³ | 400 | 70 |
| 100 | C. albicans | 1.5 × 10⁵ | 1.6 × 10³ | 1.0 × 10³ | 360 | 120 |
| | P. anomala | 6.1 × 10⁴ | 260 | 30 | 10 | 10 |

### Test Example 2

### The Effect of the Microbiostatic Agent or Microbicide Upon its Single Application

(1) The inactivation effect of a microbiostatic agent or microbicide (ε-poly-L-lysine, protamine or a grapefruit seed extract) related to the microorganism-inactivating agent of the present invention, upon its single application to water containing various microorganisms (pH 8) was studied. The concentration to which each microbiostatic agent or microbicide was added was 10 ppm. The results are shown in Table 3. By these, it can be seen that the microbiostatic agent or microbicide at a concentration of 10 ppm sufficiently inactivates microorganisms of contained in water at a concentration of 10⁴ to 10⁵ cells/mL.

Further, in terms of other ranges of pH, similar inactivation actions were exerted by ε-poly-L-lysine at a pH of 6 to 9, by protamine at a pH of 6 to 9, and by a grapefruit seed extract at a pH of 5 to 9.

TABLE 3

| | | Initial | | | |
|---|---|---|---|---|---|
| | | number of | 2 hours later | | |
| | | microbe | ε-poly-L- | | Grapefruit |
| Microbe tested | | (cells/mL) | lysine | Protamine | seed extract |
| Gram-negative | E. coli | 5.8 × 10⁴* | <10 | <10 | 60 |
| bacteria | | 4.3 × 10⁴** | | | |
| | S. choleraesuis | 4.7 × 10⁴ | <10 | <10 | ND |
| | P. aeruginosa | 2.0 × 10⁵ | <10 | <10 | ND |
| | K. pneumoniae | 1.3 × 10⁵* | <10 | 10 | 30 |
| | | 6.5 × 10⁴** | | | |
| Gram-positive | B. subtilis | 6.0 × 10⁴ | <10 | 10 | ND |
| bacteria | B. cereus | 9.5 × 10⁴* | 290 | 300 | 90 |
| | | 2.4 × 10⁴** | | | |
| | S. aureus | 4.3 × 10⁴ | <10 | <10 | ND |
| | L. monocytogenes | 2.0 × 10⁴* | <10 | <10 | <10 |
| | | 4.6 × 10⁴** | | | |

In initial number of microbe, * is for ε-poly-L-lysine and Protamine and ** is for grapefruit seed extract.

(2) The inactivation effect of ε-poly-L-lysine, which is a microbicide related to the microorganism-inactivating agent of the present invention, upon its single application to water containing various microorganisms was studied. The results are shown in Tables 4 and 5. By these, it can be seen that ε-poly-L-lysine rapidly exerts an inactivation effect against microorganisms commonly existing in rivers and lakes, although exertion of the effect is slow against Staphylococcus.

TABLE 4

| | | Initial | | | |
|---|---|---|---|---|---|
| | | number of | | | |
| ε-poly- | | microbe | 0.5 hour | 1 hour | 2 hours |
| L-lysine | Microbe tested | (cells/mL) | later | later | later |
| 5 ppm | E. coli | 3.2 × 10⁷ | 3.2 × 10³ | <10 | <10 |
| | S. choleraesuis | 1.2 × 10⁷ | 50 | 20 | <10 |
| | S. aureus | 1.2 × 10⁷ | 4.0 × 10⁴ | 2.2 × 10⁴ | 4.2 × 10³ |
| 10 ppm | E. coli | 3.2 × 10⁷ | 300 | <10 | <10 |
| | S. choleraesuis | 1.2 × 10⁷ | <10 | <10 | <10 |
| | S. aureus | 1.2 × 10⁷ | 5.0 × 10⁴ | 7.0 × 10³ | 4.8 × 10³ |

TABLE 5

| | | | | 15 | 60 | 120 |
|---|---|---|---|---|---|---|
| ε-poly-L- | | 0 minute | 5 minutes | minutes | minutes | minutes |
| lysine | Microbe tested | later | later | later | later | later |
| 10 ppm | E. coli | 2.5 × 10⁶ | 1.32 × 10⁴ | 10 | <10 | <10 |
| | S. cholerasesuis | 3.2 × 10⁵ | 480 | 1.4 × 10³ | 120 | <10 |
| | P. aeruginosa | 6.2 × 10⁵ | 2.16 × 10⁴ | 240 | 20 | <10 |
| | K. pueumoniae | 3.3 × 10⁵ | 1.8 × 10⁴ | 1.87 × 10³ | 10 | <10 |
| | B. subtilis | 2.9 × 10⁴ | 4 × 10³ | 30 | <10 | <10 |
| | B. cereus | 7.5 × 10⁴ | 140 | 110 | 80 | <10 |
| | S. aureus | 2.3 × 10⁴ | 8.1 × 10³ | 2.55 × 10³ | 2 × 10³ | 440 |
| | L. monocytogenes | 8.1 × 10⁴ | 780 | 40 | 20 | <10 |

(3) The inactivation effect of ε-poly-L-lysine, which is a microbicide related to the microorganism-inactivating agent of the present invention, upon its single application to water containing Escherichia coli, Salmonella or Staphylococcus, followed by further addition of the respective microorganisms after predetermined periods of time was studied. The addition of the microorganisms was carried out at 24, 48, 72 and 144 hours after sampling. ε-poly-L-lysine was added at a concentration of 5 ppm. The results are shown in Table 6.

By these, it can be seen that the inactivation action of ε-poly-L-lysine is maintained for a long time and that ε-poly-L-lysine also exerts the action against newly added microbes without further addition of ε-poly-L-lysine.

TABLE 6

| | | Elapsed time (hours) | | | | | | | | | |
|---|---|---|---|---|---|---|---|---|---|---|---|
| | Initial | | | | 24 (immediately | | | | 48 (immediately | | |
| | number of | | | | after further | | | | after further | | |
| Microbe | microbe | | | | addition of | | | | addition of | | |
| tested | (cells/mL) | 2 | 4 | 24 | microbe) | 26 | 28 | 48 | microbe) | 50 | 52 |
| E. coli | 1.0 × 10⁶ | <10 | <10 | <10 | 1.3 × 10⁸ | <10 | <10 | <10 | 5.0 × 10⁶ | <10 | <10 |
| S. enterica | 3.0 × 10⁶ | <10 | <10 | <10 | 3.2 × 10⁷ | <10 | <10 | <10 | 3.6 × 10⁶ | <10 | <10 |
| S. aureus | 2.0 × 10⁶ | <10 | <10 | <10 | 2.2 × 10⁷ | 2.2 × 10⁶ | 2.1 × 10⁵ | <10 | 1.4 × 10⁶ | 2.5 × 10⁴ | 1.2 × 10⁴ |

| | Elapsed time (hours) | | | | | | | | | |
|---|---|---|---|---|---|---|---|---|---|---|
| | | 72 (immediately | | | | | 144 (immediately | | | |
| | | after further | | | | | after further | | | |
| Microbe | | addition of | | | | | addition of | | | |
| tested | 72 | microbe) | 74 | 76 | 96 | 144 | microbe) | 146 | 148 | 168 |
| E. coli | <10 | 6.6 × 10⁶ | <10 | <10 | <10 | <10 | 1.2 × 10⁷ | <10 | <10 | <10 |
| S. enterica | <10 | 3.0 × 10⁶ | <10 | <10 | <10 | <10 | 3.1 × 10⁶ | <10 | <10 | <10 |
| S. aureus | <10 | 6.1 × 10⁶ | 1.7 × 10³ | 20 | <10 | <10 | 7.9 × 10⁶ | 1.0 × 10³ | 90 | <10 |

### Test Example 3

### The Combination Effect of the Microorganism-Inactivating Agent Further Containing a Microbicide

(1) The inactivation effect by addition of PGα21Ca and ε-poly-L-lysine to water containing Escherichia coli, Salmonella or Staphylococcus (at an initial cell number in the order of 10³ to 10⁶ cells/mL for each), to concentrations of 50 or 100 ppm and 0 to 5 ppm, respectively, was studied. Within these ranges, in almost all the cases, the number of surviving bacteria became <10 cells/mL within 2 hours. As representative examples, results obtained by addition of PGα21Ca and ε-poly-L-lysine to water containing Escherichia coli (at an initial cell number of 1.1×10⁶ cells/mL), Salmonella (at an initial cell number of 5.2×10⁶ cells/mL) or Staphylococcus (at an initial cell number of 2.6×10⁶ cells/mL) to concentrations of 50 ppm and 0 to 5 ppm, respectively, are shown in Table 7. Further, results obtained by addition of PGα21Ca and ε-poly-L-lysine to water containing Escherichia coli (at an initial cell number of 7.6×10⁶ cells/mL), Salmonella (at an initial cell number of 1.5×10⁶ cells/mL) or Staphylococcus (at an initial cell number of 1.4×10⁶ cells/mL) to concentrations of 100 ppm and 0 to 5 ppm, respectively, are shown in Table 8.

From these, it can be seen that, at a mass concentration ratio between the composition containing as a major component(s) γ-polyglutamic acid and/or cross-linked product of γ-polyglutamic acid and ε-poly-L-lysine as a microbicide within the range of 1:10 to 500:1, microorganisms in water could be inactivated to a level at which the water is drinkable.

TABLE 7

| | ε-poly-L- | | | | |
|---|---|---|---|---|---|
| PGα21Ca | lysine | Microbe | 0.5 hour | 1 hour | 2 hours |
| (ppm) | (ppm) | tested | later | later | later |
| 50 | 0 | E. coli | 6.3 × 10⁴ | 2.6 × 10⁴ | 730 |
| | | S. enterica | 5.5 × 10⁴ | 1.4 × 10⁴ | 560 |
| | | S. aureus | 6.8 × 10³ | 520 | 540 |
| | 0.5 | E. coli | 1.5 × 10³ | 30 | 10 |
| | | S. enterica | 2.1 × 10⁴ | 1.0 × 10⁴ | 3.4 × 10³ |
| | | S. aureus | 280 | 20 | <10 |
| | 1 | E. coli | <10 | <10 | <10 |
| | | S. enterica | 1.9 × 10⁴ | 810 | 30 |
| | | S. aureus | 20 | <10 | <10 |
| | 1.5 | E. coli | <10 | <10 | <10 |
| | | S. enterica | 1.7 × 10⁴ | 1.0 × 10³ | 30 |
| | | S. aureus | 10 | <10 | <10 |
| | 2 | E. coli | <10 | <10 | <10 |
| | | S. enterica | 1.4 × 10³ | 80 | <10 |
| | | S. aureus | <10 | <10 | <10 |
| | 2.5 | E. coli | <10 | <10 | <10 |
| | | S. enterica | 2.2 × 10³ | 80 | <10 |
| | | S. aureus | <10 | <10 | 20 |
| | 3 | E. coli | <10 | <10 | <10 |
| | | S. enterica | 950 | 20 | <10 |
| | | S. aureus | <10 | <10 | <10 |
| | 3.5 | E. coli | <10 | <10 | <10 |
| | | S. enterica | 70 | <10 | <10 |
| | | S. aureus | <10 | <10 | <10 |
| | 4 | E. coli | <10 | <10 | <10 |
| | | S. enterica | 50 | <10 | <10 |
| | | S. aureus | <10 | <10 | <10 |
| | 4.5 | E. coli | <10 | <10 | <10 |
| | | S. enterica | 40 | <10 | <10 |
| | | S. aureus | <10 | <10 | <10 |
| | 5 | E. coli | <10 | <10 | <10 |
| | | S. enterica | 50 | <10 | <10 |
| | | S. aureus | <10 | <10 | <10 |

TABLE 8

| | ε-poly-L- | | | | |
|---|---|---|---|---|---|
| PGα21Ca | lysine | Microbe | 0.5 hour | 1 hour | 2 hours |
| (ppm) | (ppm) | tested | later | later | later |
| 100 | 0 | E. coli | 4.0 × 10⁵ | 6.2 × 10⁴ | 4.2 × 10³ |
| | | S. enterica | 2.0 × 10⁴ | 3.0 × 10³ | 100 |
| | | S. aureus | 590 | 200 | 60 |
| | 0.5 | E. coli | 20 | <10 | <10 |
| | | S. enterica | 2.8 × 10³ | 100 | <10 |
| | | S. aureus | 100 | <10 | <10 |
| | 1 | E. coli | <10 | <10 | <10 |
| | | S. enterica | 500 | 70 | <10 |
| | | S. aureus | 10 | <10 | <10 |
| | 1.5 | E. coli | <10 | <10 | <10 |
| | | S. enterica | 400 | 10 | <10 |
| | | S. aureus | <10 | <10 | <10 |
| | 2 | E. coli | <10 | <10 | <10 |
| | | S. enterica | 450 | 40 | <10 |
| | | S. aureus | <10 | <10 | <10 |
| | 2.5 | E. coli | <10 | <10 | <10 |
| | | S. enterica | 10 | <10 | <10 |
| | | S. aureus | 10 | <10 | <10 |
| | 3 | E. coli | <10 | <10 | <10 |
| | | S. enterica | <10 | <10 | <10 |
| | | S. aureus | <10 | 10 | <10 |
| | 3.5 | E. coli | <10 | <10 | <10 |
| | | S. enterica | <10 | <10 | <10 |
| | | S. aureus | <10 | <10 | <10 |
| | 4 | E. coli | <10 | <10 | <10 |
| | | S. enterica | <10 | <10 | <10 |
| | | S. aureus | <10 | <10 | <10 |
| | 4.5 | E. coli | <10 | <10 | <10 |
| | | S. enterica | <10 | <10 | <10 |
| | | S. aureus | <10 | <10 | <10 |
| | 5 | E. coli | <10 | <10 | <10 |
| | | S. enterica | <10 | <10 | <10 |
| | | S. aureus | <10 | <10 | <10 |

(2) The inactivation effect by addition of PGα21Ca and ε-poly-L-lysine to water containing yeast, to concentrations of 50 or 100 ppm and 0 to 100 ppm, respectively, was studied. The results obtained for C. albicans are shown in Table 9, and the results obtained for P. anomala are shown in Table 10.

From these, it can be seen that, at a mass concentration ratio between the composition containing as a major component(s) γ-polyglutamic acid and/or cross-linked product of γ-polyglutamic acid and e-poly-L-lysine as a microbicide within the range of 1:10 to 500:1, the yeast in water could be inactivated to a level at which the water is drinkable.

TABLE 9

| | | Initial | | | |
|---|---|---|---|---|---|
| | ε-poly-L- | number of | Elapsed time | | |
| PGα21Ca | lysine | microbe | 0.5 hour | 1 hour | 2 hours |
| (ppm) | (ppm) | (cells/mL) | later | later | later |
| 50 | 0 | 1.8 × 10⁵ | 4.7 × 10⁴ | 2.7 × 10⁴ | 1.8 × 10⁴ |
| | 5 | | 1.8 × 10³ | 230 | <10 |
| | 10 | | 50 | <10 | <10 |
| | 50 | | <10 | <10 | <10 |
| | 100 | | <10 | <10 | <10 |
| 100 | 0 | | 3.4 × 10³ | 2.4 × 10³ | 1.0 × 10³ |
| | 5 | | 3.6 × 10³ | 2.4 × 10³ | 4.2 × 10³ |
| | 10 | | 150 | <10 | <10 |
| | 50 | | <10 | <10 | <10 |
| | 100 | | <10 | <10 | <10 |

TABLE 10

| | | Initial | | | |
|---|---|---|---|---|---|
| | ε-poly-L- | number of | Elapsed time | | |
| PGα21Ca | lysine | microbe | 0.5 hour | 1 hour | 2 hours |
| (ppm) | (ppm) | (cells/mL) | later | later | later |
| 50 | 0 | 7.0 × 10⁴ | 6.5 × 10⁴ | 4.5 × 10⁴ | 3.4 × 10³ |
| | 5 | | <10 | <10 | <10 |
| | 10 | | <10 | <10 | <10 |
| | 50 | | <10 | <10 | <10 |
| | 100 | | <10 | <10 | <10 |
| 100 | 0 | | 160 | 50 | <10 |
| | 5 | | 10 | <10 | <10 |
| | 10 | | 10 | <10 | <10 |
| | 50 | | <10 | <10 | <10 |
| | 100 | | <10 | <10 | <10 |

(3) The inactivation effect by addition of PGα21Ca and ε-poly-L-lysine to water containing Escherichia coli, Salmonella or Staphylococcus, to concentrations of 50 or 100 ppm and 5 ppm, respectively, followed by further addition of the respective microorganisms after predetermined periods of time was studied. The addition of the microorganisms was carried out at 24, 48 and 72 hours after sampling. The results of addition of PGα21Ca and ε-poly-L-lysine to concentrations of 50 ppm and 5 ppm, respectively, are shown in Table 11, and the results of addition of PGα21Ca and ε-poly-L-lysine to concentrations of 100 ppm and 5 ppm, respectively, are shown in Table 12. As in the above-mentioned single application of ε-poly-L-lysine, the action of the microorganism-inactivating agent of the present invention was maintained for long time, and the effect was also exerted against the newly added bacteria without further addition of the inactivating agent.

TABLE 11

| | | Elapsed time (hours) | | | | | | | | | | | | | |
|---|---|---|---|---|---|---|---|---|---|---|---|---|---|---|---|
| | | | | | 24 | | | | | | | | 72 | | |
| | | | | | (immed- | | | | 48 | | | | (immed- | | |
| | Initial | | | | iately after | | | | (immediately | | | | iately after | | |
| | number of | | | | further | | | | after further | | | | further | | |
| Microbe | microbe | | | | addition of | | | | addition of | | | | addition of | | |
| tested | (cells/mL) | 2 | 4 | 24 | microbe) | 26 | 28 | 48 | microbe) | 50 | 52 | 72 | microbe) | 74 | 76 |
| E. coli | 3.6 × 10⁶ | <10 | <10 | <10 | 3.3 × 10⁶ | <10 | <10 | <10 | 3.2 × 10⁶ | <10 | <10 | <10 | 4.1 × 10⁶ | <10 | <10 |
| S. enterica | 1.6 × 10⁵ | <10 | <10 | <10 | 3.8 × 10⁵ | <10 | <10 | <10 | 4.2 × 10⁵ | <10 | <10 | <10 | 6.8 × 10⁶ | <10 | <10 |
| S. aureus | 2.5 × 10⁶ | <10 | <10 | <10 | 7.5 × 10⁵ | 970 | 80 | <10 | 1.0 × 10⁶ | 170 | 10 | <10 | 2.1 × 10⁶ | 2.5 × 10⁴ | 2.1 × 10³ |

TABLE 12

| | | Elapsed time (hours) | | | | | | | | | | | | | |
|---|---|---|---|---|---|---|---|---|---|---|---|---|---|---|---|
| | | | | | 24 | | | | 48 | | | | 72 | | |
| | Initial | | | | (immediately | | | | (immediately | | | | (immediately | | |
| | number of | | | | after further | | | | after further | | | | after further | | |
| Microbe | microbe | | | | addition of | | | | addition of | | | | addition of | | |
| tested | (cells/mL) | 2 | 4 | 24 | microbe) | 26 | 28 | 48 | microbe) | 50 | 52 | 72 | microbe) | 74 | 76 |
| E. coli | 3.6 × 10⁶ | <10 | <10 | <10 | 3.3 × 10⁶ | <10 | <10 | <10 | 3.2 × 10⁶ | <10 | <10 | <10 | 4.1 × 10⁶ | <10 | <10 |
| S. enterica | 1.6 × 10⁵ | 120 | 10 | <10 | 3.8 × 10⁵ | <10 | <10 | <10 | 4.2 × 10⁵ | <10 | <10 | <10 | 6.8 × 10⁶ | <10 | <10 |
| S. aureus | 2.5 × 10⁶ | <10 | <10 | <10 | 7.5 × 10⁵ | 60 | <10 | <10 | 1.0 × 10⁶ | 110 | <10 | <10 | 2.1 × 10⁶ | 1.3 × 10³ | 480 |

### INDUSTRIAL APPLICABILITY

By the present invention, microorganisms in water can be simply inactivated, and drinking water and domestic water can be simple obtained, which is industrially very useful.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A microorganism-inactivating agent comprising a composition containing γ-polyglutamic acid and/or cross-linked product of γ-polyglutamic acid; a calcium ion donor; a sodium ion donor; and an aluminum ion donor.

2. The microorganism-inactivating agent according to claim 1, further comprising one or more selected from microbiostatic agents and microbicides.

3. The microorganism-inactivating agent according to claim 2, wherein said microbiostatic agents and microbicides are cationic compound.

4. The microorganism-inactivating agent according to claim 3, wherein said cationic compound is polypeptide mainly consisting of basic amino acids.

5. The microorganism-inactivating agent according to claim 4, wherein said polypeptide is ε-poly-L-lysine.

6. The microorganism-inactivating agent according to claim 5, wherein the mass ratio between the contents of said composition and said ε-poly-L-lysine is 1:10 to 500:1.

7. A method for inactivating a microorganism in water containing said microorganism, comprising a step of bringing a composition containing γ-polyglutamic acid and/or cross-linked product of γ-polyglutamic acid; a calcium ion donor; a sodium ion donor; and an aluminum ion donor into contact with said water containing said microorganism.

8. The method according to claim 7, wherein said step of bringing the composition into contact with water comprises adding said composition to said water containing said microorganism and stirring said water after the addition.

9. The method according to claim 7, wherein said microorganism belongs to the genus Staphylococcus.

10. The method according to claim 7, further comprising a step of bringing one or more selected from microbiostatic agents and microbicides into contact with said water containing said microorganism.

11. The method according to claim 10, wherein a composition containing γ-polyglutamic acid and/or cross-linked product of γ-polyglutamic acid; a calcium ion donor; a sodium ion donor; and an aluminum ion donor; and one or more selected from microbiostatic agents and microbicides are added to water at the same time and brought into contact with the water.

12. The method according to claim 10 wherein said microbiostatic agents and microbicides are cationic compound.

13. The method according to claim 12, wherein said cationic compound is polypeptide mainly consisting of basic amino acids.

14. The method according to claim 13, wherein said polypeptide is ε-poly-L-lysine.

15. The method according to claim 14, wherein said composition is added to a concentration of 1 to 50000 ppm and said ε-poly-L-lysine is added to a concentration of 0.1 to 100 ppm.

16. The method according to claim 14, wherein said composition and said ε-poly-L-lysine is added such that the mass concentration ratio between them is 1:10 to 500:1.

17. A method for producing drinking water comprising inactivating a microorganism in water by the method according to claim 10.
